(19) United States
(12) Patent Application Publication
(10) Pub. No.: US 2022/0135113 A1
(43) Pub. Date: May 5, 2022

(54) STEERING OPERATING DEVICE AND STEERING SYSTEM FOR VEHICLE

(71) Applicant: TOYOTA JIDOSHA KABUSHIKI KAISHA, Toyota-shi (JP)

(72) Inventor: Takatoshi SUGIURA, Nagoya-shi (JP)

(73) Assignee: TOYOTA JIDOSHA KABUSHIKI KAISHA, Toyota-shi (JP)

(21) Appl. No.: 17/515,768

(22) Filed: Nov. 1, 2021

(30) Foreign Application Priority Data
Nov. 3, 2020 (JP) 2020-184030

(51) Int. Cl. B62D 1/183

(52) U.S. Cl. CPC B62D 1/183

(57) ABSTRACT

A steering operating device provided for a vehicle whose driving state is switchable between a manual driving state and an automatic driving state and including a steering operating member operable by a driver, including: an upstream portion including the steering operating member; a downstream portion located downstream of the upstream portion; and a link member connecting the upstream portion and the downstream portion, wherein the link member connects the upstream portion and the downstream portion such that the upstream portion is movable relative to the downstream portion in a width direction of the vehicle and such that the upstream portion is pivotable relative to the downstream portion in an up-down direction of the vehicle.

### CROSS REFERENCE TO RELATED APPLICATION

The present application claims priority to Japanese Patent Application No. 2020-184030, which was filed on Nov. 3, 2020, the disclosure of which is herein incorporated by reference in its entirety.

### BACKGROUND

### Technical Field

The following disclosure relates to a steering operating device and a steering system provided for a vehicle whose driving state is switchable between a manual driving state and an automatic driving state.

### Description of Related Art

Patent Document (Japanese Patent Application Publication No. 2020-142539) discloses a vehicle steering system including a steering operating device provided for a vehicle whose driving state is switchable between a manual driving state and an automatic driving state. The disclosed steering system is of a steer-by-wire type. The steering operating device is held by a body of the vehicle so as to be movable by a slide device in a width direction of the vehicle, and a steering operating member is held by a main body of the steering operating device so as to be pivotable by a pivotal device about an axis extending in a horizontal direction. When the driving state of the vehicle is switched from the manual driving state to the automatic driving state, the steering operating device is moved by the slide device to a widthwise central portion of the vehicle and the steering operating member is pivoted upward by the pivotal device. This configuration enables a space in front of a driver's seat to be enlarged when the vehicle is in the automatic driving state.

### SUMMARY

An aspect of the present disclosure is directed to an improvement of a steering operating device and a steering system provided for a vehicle whose driving state is switchable between a manual driving state and an automatic driving state, more specifically, a simplification of a structure of the device and the system.

In the steering operating device and the steering system according to the present disclosure, an upstream portion including a steering operating member is connected to a downstream portion by a link member so as to be movable in a width direction of the vehicle and pivotable in an up-down direction of the vehicle. The link member enables the upstream portion including the steering operating member to be moved in the width direction of the vehicle and pivoted in the up-down direction of the vehicle, thus eliminating a need of separately providing the slide device for moving the steering operating device in the width direction and the pivotal device for pivoting the steering operating member about the axis extending in the horizontal direction, as conventionally required in the steering operating device and the steering system disclosed in the Patent Document 1. Consequently, the steering operating device and the steering system are simple in structure.

### BRIEF DESCRIPTION OF THE DRAWINGS

The objects, features, advantages, and technical and industrial significance of the present disclosure will be better understood by reading the following detailed description of embodiments, when considered in connection with the accompanying drawings, in which:

FIG. 1 is a view conceptually illustrating a vehicle steering system including a vehicle steering operating device according to a first embodiment of the present disclosure;

FIG. 2 is a cross-sectional view of a steering operating member and components therearound in the steering system;

FIG. 3 is a front view conceptually illustrating a rotation lock device of the steering system;

FIG. 4A is a view conceptually illustrating a non-operating state of the rotation lock device;

FIG. 4B is a view conceptually illustrating an operating state of the rotation lock device;

FIG. 5 is a rear view conceptually illustrating a steering operating member holder provided for a pillar of a vehicle for which the steering system is provided;

FIG. 6 is a view illustrating a controller and components therearound in the steering system;

FIG. 7A is a view conceptually illustrating a state in which an upstream portion with the steering operating member of the steering operating device is separated from a downstream portion of the steering operating device;

FIG. 7B is a view conceptually illustrating a state in which the upstream portion is moved relative to the downstream portion in a width direction of the vehicle;

FIG. 7C is a view conceptually illustrating a state in which the upstream portion is pivoted upward relative to the downstream portion;

FIG. 8 is a view conceptually illustrating a vehicle steering system including a vehicle steering operating device according to a second embodiment of the present disclosure;

FIG. 9 is a cross-sectional view of the steering operating member and components therearound in the steering system of the second embodiment; and

FIG. 10 is a view of a controller and components therearound in the steering system of the second embodiment.

### DETAILED DESCRIPTION OF THE EMBODIMENTS

Referring to the drawings, there will be hereinafter described a vehicle steering system according to one embodiment of the present disclosure including a vehicle steering operating device according to one embodiment of the present disclosure. The present steering system is provided for a vehicle whose driving state is switchable between an automatic driving state and a manual driving state.

### First Embodiment

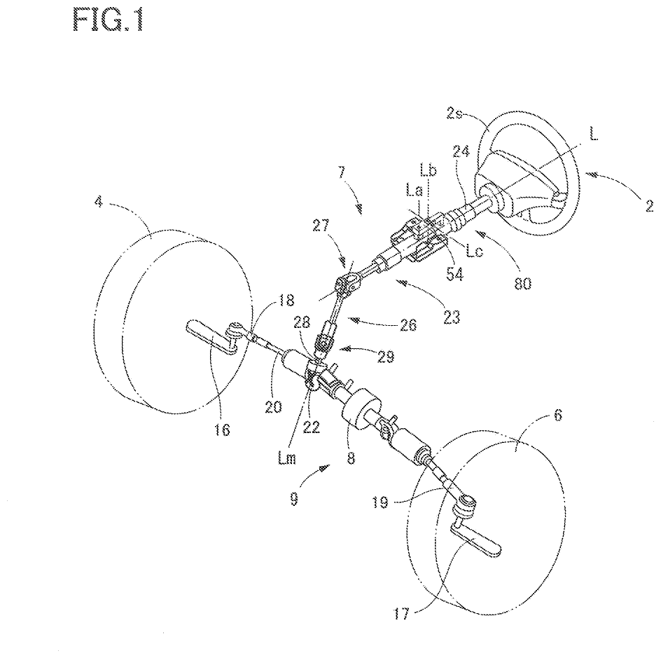

In the steering system illustrated in FIG. 1, a steering operating member 2 operable by a driver and front right and left wheels 4, 6 of the vehicle each as at least one steerable wheel are coupled by a coupling mechanism 7. In the manual driving state of the vehicle, the coupling mechanism 7 is in a mechanically coupling state in which the coupling mechanism 7 mechanically couples the steering operating member 2 and the front right and left wheels 4, 6 to each other. When the driving state of the vehicle is switched from the manual driving state to the automatic driving state, the mechanical coupling between the steering operating member 2 and the front right and left wheels 4, 6 are disengaged. In the automatic driving state of the vehicle, the coupling mechanism 7 is in a mechanically decoupling state.

The front right and left wheels 4, 6 are coupled to each other by knuckle link members 16, 17, tie rods 18, 19, and a rack bar 20. A pinion gear (not illustrated) provided at a distal end portion of the steering shaft 23 is in engagement with a toothed portion of the rack bar 20 in a steering gear box (hereinafter simply referred to as “gear box”) 22. An automatic steering device 8 is provided for the rack bar 20.

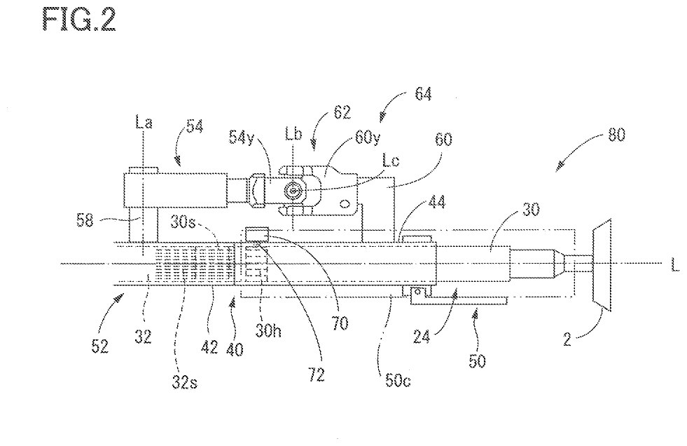

The steering shaft 23 includes a first shaft 24, a second shaft 26, an output rod 28, etc. As illustrated in FIG. 2, the first shaft 24 is rotatable integrally with the steering operating member 2 about an axis L of the steering operating member 2 and the first shaft 24 (hereinafter simply referred to as “about the axis” where appropriate). The second shaft 26 is coupled to the first shaft 24 via a universal joint 27 so as to be rotatable integrally with the first shaft 24 about an axis Lm of the second shaft 26. The output rod 28 is coupled to the second shaft 26 via a universal joint 29. The pinion gear described above is provided for the output rod 28 so as to be rotatable integrally with the output rod 28.

When an operation torque is applied to the steering operating member 2 and the steering operating member 2 is thereby rotated about the axis, the steering shaft 23 is twisted by the rotation of the steering operating member 2 and the pinion gear is rotated. The rotation of the pinion gear is transmitted to the rack bar 20 via the gear box 22, and the rack bar 20 is moved in a width direction, namely, a right-left direction, of the vehicle, so that the front right and left wheels 4, 6 are steered. The operation torque applied to the steering operating member 2 is transmitted to the rack bar 20 via the steering shaft 23 and the gear box 22 and is then applied to the front right and left wheels 4, 6. In the present embodiment, the state in which the operation torque applied to the steering operating member 2 is mechanically transmitted to the front right and left wheels 4, 6 is the mechanically coupling state of the coupling mechanism 7.

In the present embodiment, the gear box 22 has a motion converting function of converting the rotation of the steering shaft 23 into the linear movement of the rack bar 20. The gear box 22 includes the pinion gear, the toothed portion of the rack bar 20, etc. A steering mechanism 9 is constituted by the knuckle link members 16, 17, the tie rods 18, 19, the rack bar 20, etc. The coupling mechanism 7 includes the steering shaft 23, the steering mechanism 9, the gear box 22, etc.

The first shaft 24 extends generally in a front-rear direction of the vehicle. As illustrated in FIG. 2, the first shaft 24 includes an upstream shaft 30 that is connected to the steering operating member 2 so as to be rotatable about the axis integrally with the steering operating member 2 and a downstream shaft 32 located downstream of the upstream shaft 30. The upstream shaft 30 and the downstream shaft 32 are engageable with and separable from each other. A downstream end portion (that may be referred to as a front-side end portion) of the upstream shaft 30 has a diameter smaller than that of an intermediate portion thereof. Serrations 30s having a plurality of protrusions and recesses are formed at an outer circumferential portion of the downstream end portion of the upstream shaft 30.

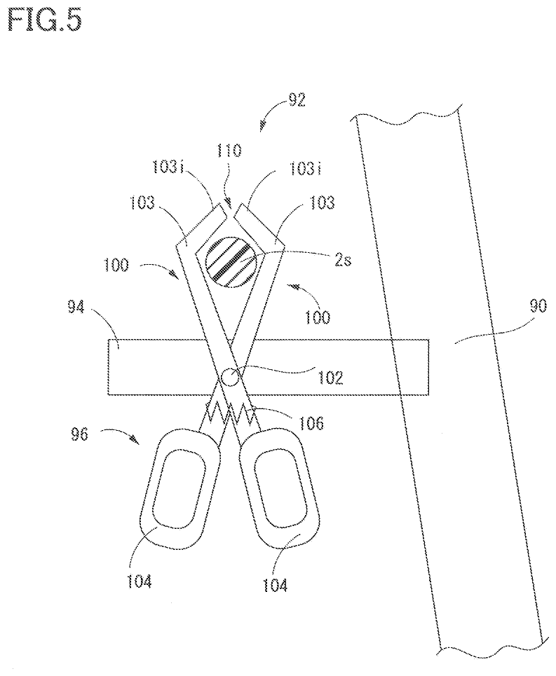

A pin holder 30h is provided at a downstream portion of the intermediate portion of the upstream shaft 30. The pin holder 30h includes a plurality of engagement recesses 30r formed at an outer circumferential portion of the upstream shaft 30. In other words, a plurality of protrusions and recesses are formed at the outer circumferential portion of the upstream shaft 30, and a space between any adjacent two of the protrusions functions as each of the engagement recesses 30r. Each engagement recess 30r is dimensioned such that a lock pin 72 (that will be described) is insertable thereinto, as illustrated in FIGS. 4A and 4B.

Serrations 32s having a plurality of protrusions and recesses are formed at an inner circumferential surface of an upstream end portion of the downstream shaft 32. The serrations 32s are engageable with the serrations 30s of the upstream shaft 30. The engagement of the serrations 32s and the serrations 30s may be referred to as serration engagement.

In a state in which the upstream shaft 30 and the downstream shaft 32 are held in serration engagement, the upstream shaft 30 and the downstream shaft 32 are in engagement with each other. In a state in which the serration engagement is canceled, the upstream shaft 30 and the downstream shaft 32 are separated from each other.

The first shaft 24 is held by a column 40, which is supported by a vehicle body (not illustrated), so as to be rotatable about the axis. The column 40 includes a downstream column 42 fixed to the vehicle body (not illustrated) and an upstream column 44 located upstream of the downstream column 42 so as to be movable toward and away from the downstream column 42.

The upstream shaft 30 is held by the upstream column 44 so as to be rotatable relative to the upstream column 44 about the axis. The downstream shaft 32 is held by the downstream column 42 so as to be rotatable relative to the downstream column 42 about the axis and immovable, in principle, relative to the downstream column 42 in a direction that is the same as or parallel to the axis L. (This direction will be referred to as “axial direction” where appropriate”.)

The steering operating member 2, the upstream column 44, the upstream shaft 30, etc., constitute an upstream portion 50 while the downstream column 42, the downstream shaft 32, etc., constitute a downstream portion 52. The upstream column 44 and the upstream shaft 30 are covered with a column cover 50c.

The upstream column 44 and the downstream column 42 are connected by a link member 54.

The link member 54 is connected, at a downstream end portion thereof, to a downstream link connector 58 fixed to the downstream column 42, such that the link member 54 is pivotable about an axis La extending in the up-down direction. The link member 54 is connected, at an upstream end portion thereof, to an upstream link connector 60 fixed to the upstream column 44 via a universal joint 62. A yoke 54y is provided at the upstream end portion of the link member 54, and a yoke 60y is provided at a downstream end portion of the upstream link connector 60. The yoke 54y and the yoke 60y are connected to each other via a cross joint (not illustrated). In the present embodiment, the universal joint 62 includes the yoke 54y provided for the link member 54, the yoke 60y provided for the upstream link connector 60, the cross joint, etc. At the universal joint 62, the upstream link connector 60 is connected to the link member 54 so as to be pivotable about an axis Lc extending in the horizontal direction and an axis Lb extending in the up-down direction. The link member 54 has a telescopic structure at an intermediate portion thereof. Thus, the link member 54 is configured to extend and contract.

In the present embodiment, a link mechanism 64 is constituted by the downstream column 42 (the downstream link connector), the upstream column 44 (the upstream link connector 60), the link member 54, etc.

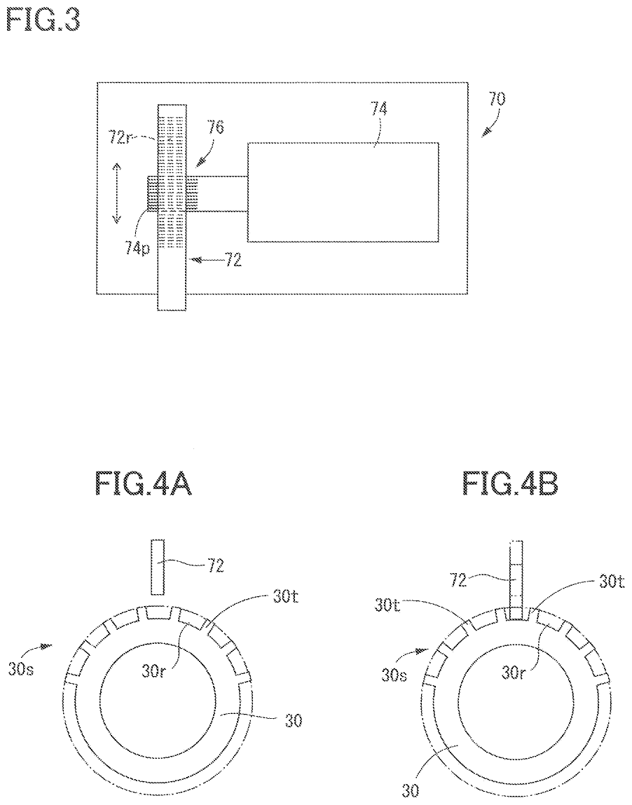

As illustrated in FIG. 3, a rotation lock device 70 is provided for the upstream column 44. The rotation lock device 70 is configured to prohibit rotation of the upstream shaft 30 relative to the upstream column 44 about the axis in a state in which the upstream portion 50 and the downstream portion 52 are separated from each other. The rotation lock device 70 is configured to switch a state of the relative rotation of the upstream shaft 30 and the upstream column 44 between a locked state in which the rotation of the upstream shaft 30 relative to the upstream column 44 about the axis is prohibited and a free state in which the rotation of the upstream shaft 30 relative to the upstream column 44 about the axis is allowed. The rotation lock device 70 includes the lock pin 72, an electric motor 74, as a drive source, for moving the lock pin 72, a rack and pinion mechanism 76, as one example of a motion converting mechanism, disposed between the electric motor 74 and the lock pin 72. The electric motor 74 is held by a main body (not illustrated) of the rotation lock device 70.

A pinion gear 74p is provided on a rotation shaft of the electric motor 74, and a plurality of tooth portions 72r are formed on the lock pin (functioning as a rack bar) 72 so as to be arranged in a longitudinal direction of the lock pin 72. The pinion gear 74p and the tooth portions 72r are in mesh with each other. When the electric motor 74 is activated and the rotation shaft thereof is rotated, the pinion gear 74p is rotated to linearly move the lock pin 72 having the tooth portions 72r in directions indicated by the arrow in FIG. 3.

When the lock pin 72 is located at a retracted position at which the lock pin 72 is spaced apart from the pin holder 30h of the upstream shaft 30 as illustrated in FIG. 4A, the relative rotation state of the upstream shaft 30 and the upstream column 44 is the free state in which the rotation of the upstream shaft 30 relative to the upstream column 44 about the axis is allowed. When the lock pin 72 is located at an engaging position at which the distal end portion the lock pin 72 is engaged in one of the engagement recesses 30r (that is defined by a space between adjacent two protrusions 30t, 30t) of the pin holder 30h as illustrated in FIG. 4B, the relative rotation state of the upstream shaft 30 and the upstream column 44 is the locked state in which the rotation of the upstream shaft 30 relative to the upstream column 44 is prohibited.

In the present embodiment, a steering operating device 80 is constituted by the first shaft 24, the column 40, the steering operating member 2, the link member 54, the rotation lock device 70, and components therearound. In the manual driving state of the vehicle, the steering operating device 80 is connected to the gear box 22 via the second shaft 26, the output rod 28, etc.

As illustrated in FIG. 5, there is provided, for an A pillar 90 that is a pillar disposed at a front portion of the vehicle, one example of a steering operating member holder 92 for holding the steering operating member 2. The steering operating member holder 92 includes a gripper 96 attached to a bracket 94 provided on the A pillar 90. The gripper 96 is operable by an operator and includes a pair of openable and closable holding portions 100 and a pin 102 connecting the holding portions 100 at respective intermediate positions thereof.

Each holding portion 100 is shaped like a rod having a curved portion 103. Each holding portion 100 has an operating portion 104 located opposite to the curved portion 103 with respect to the pin 102. An opening portion 110 is defined by a pair of end portions 103i of the curved portions 103 of the respective holding portions 100. A spoke 2s of the steering operating member 2 is insertable into a space between the curved portions 103.

In a normal state of the gripper 96 illustrated in FIG. 5, the operating portions 104 are located close to each other owing to a return spring 106, the end portions 103i are located close to each other, and the opening portion 110 is closed. When the operator causes the operating portions 104 to move away from each other against the elastic force of the return spring 106 to thereby move the end portions 103i away from each other, the opening portion 110 is opened. Thus, the spoke 2s of the steering operating member 2 is insertable through the opening portion 110. The operator inserts the spoke 2s of the steering operating member 2 through the opening portion 110 and relaxes the force applied to the operating portions 104. Thus, the operating portions 104 are brought close to each other by the return spring 106, so that the end portions 103i are brought close to each other and the opening portion 110 is closed. In this way, the spoke 2s of the steering operating member 2 is held by the curved portions 103.

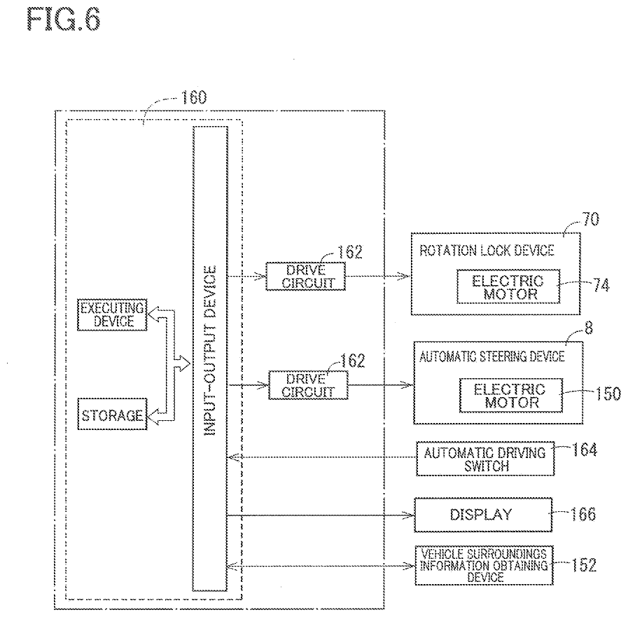

The automatic steering device 8 steers the front right and left wheels 4, 6 by moving the rack bar 20 in the width direction in the automatic driving state of the vehicle. The automatic steering device 8 provided for the rack bar 20 includes an electric motor 150 (FIG. 6) and a motion converting mechanism (not illustrated) for converting rotation of the electric motor 150 into the linear movement of the rack bar 20. In the automatic driving state, the electric motor 150 is controlled based on information obtained by a vehicle surroundings information obtaining device 152 (FIG. 6) configured to obtain information on surrounding environment of the vehicle, whereby the steering angle of the front right and left wheels 4, 6 are controlled. The vehicle surroundings information obtaining device 152 includes a camera, radar, etc., and obtains an object present in the surroundings of the vehicle, a lane line, etc., based on images taken by the camera, the radar, etc.

As illustrated in FIG. 6, the steering system is controlled by a controller 160 constituted principally by a computer. The controller 160 includes an executing device, a storage, an input/output device, etc. There are connected, to the input/output device, the electric motor 74 as the drive source of the rotation lock device 70, the electric motor 150 as the drive source of the automatic steering device 8, etc., via respective drive circuits 162. Further, the vehicle surroundings information obtaining device 152, an automatic driving switch 164, a display 166, etc., are connected to the input/output device.

The automatic driving switch 164 is operated by the driver when the driving state of the vehicle is switched between the automatic driving state and the manual driving state. In an OFF state of the automatic driving switch 164, the vehicle is in the manual driving state. When the automatic driving switch 164 is turned to ON, the driving state of the vehicle is switched from the manual driving state to the automatic driving state. The driving state of the vehicle (the automatic driving state or the manual driving state), namely, the ON/OFF state of the automatic driving switch 164, is indicated on the display 166.

In the thus constructed steering system, when the automatic driving switch 164 is turned to ON by the driver, for instance, the rotation lock device 70 is operated and the electric motor 74 is activated to permit the lock pin 72 to protrude toward the upstream shaft 30. The distal end portion of the lock pin 72 is inserted into one of the engagement recesses 30r of the pin holder 30h formed at the outer circumferential portion of the upstream shaft 30, whereby the steering operating member 2 and the upstream shaft 30 are prohibited from rotating relative to the upstream column 44.

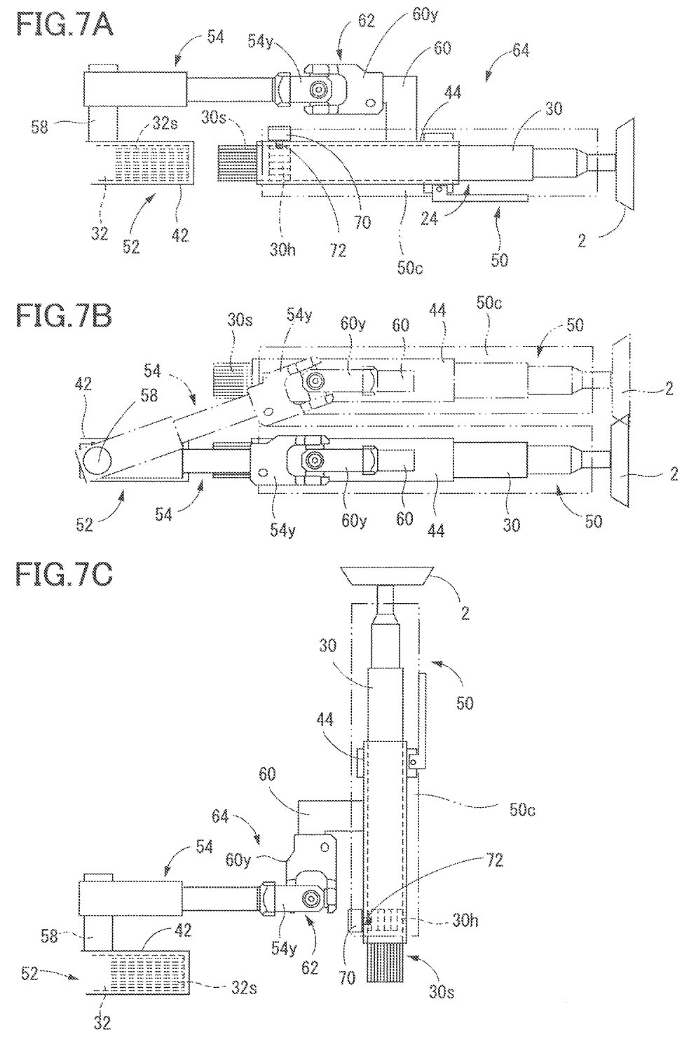

The driver subsequently pulls the upstream portion 50 rearward, namely, toward the upstream side, as illustrated in FIG. 7A to thereby separate the upstream portion 50 from the downstream portion 52. This action will be referred to as a separating step. In the present embodiment, the upstream portion 50 is not pushed forward, namely, toward the downstream side, but is pulled rearward, whereby the upstream portion 50 and the downstream portion 52 are separated from each other. Thus, the mechanical coupling between the steering operating member 2 and the front right and left wheels 4, 5 is disengaged, so that the coupling mechanism 7 is switched to the mechanically decoupling state. The front right and left wheels 4, 5 are steered by the automatic steering device 8. The electric motor 150 of the automatic steering device 8 is controlled based on the information obtained by the vehicle surroundings information obtaining device 152, etc.

The driver then moves the upstream portion 50 in the width direction of the vehicle as illustrated in FIG. 7B. This action will be referred to as a width-direction moving step.

The link member 54 is pivoted relative to the downstream column 42 about the axis La and is extended at the intermediate portion thereof. The upstream portion 50 is pivoted, at the universal joint 62, relative to the link member 54 about the axis Lb. Though the upstream portion 50 can be moved parallely in the width direction of the vehicle by the universal joint 62 in FIG. 7B, the upstream portion 50 may take any posture. In the present embodiment, the driver moves the upstream portion 50 in the width direction of the vehicle toward a door.

The driver then pivots the upstream portion 50 upward about the axis Lc as illustrated in FIG. 7C. This action will be referred to as a swinging step. The spoke 2s of the steering operating member 2 is held by the gripper 96. This action will be referred to as a holding step.

In this way, in the mechanically decoupling state of the coupling mechanism 7, namely, in the automatic driving state of the vehicle, the steering operating member 2 is first moved toward the door of a driver's seat in the vehicle, then swung upward, and finally held by the gripper 96 provided for the A pillar 90. This configuration can enlarge a space in the neighborhood of the driver's seat. In this configuration, the upstream portion 50 is not moved toward the widthwise central portion of the vehicle but is moved toward the door, resulting in an increased space at the widthwise central portion of the vehicle. This configuration allows the driver to interact an occupant or occupants sitting in a rear seat of the vehicle in a state in which the driver is sitting in the driver's seat, and improves cabin comfort of the vehicle in the automatic driving state.

In the steering operating device and the steering system according to the present embodiment, the link member connecting the downstream portion 52 and the upstream portion 50 enables the steering operating member 2 to be moved in the width direction and pivoted upward without the slide device, the pivotal device, etc. Consequently, the steering operating device and the steering system according to the present embodiment is simplified in structure, as compared with the steering system including the steering operating device disclosed in the Patent Document 1.

When the driving state of the vehicle is switched from the automatic driving state to the manual driving state, the driver operates the gripper 96 to cause the steering operating member 2 held by the gripper 96 to be released therefrom, pivots the upstream portion 50 downward, and moves the upstream portion 50 in the width direction so as to align the upstream shaft 30 with the downstream shaft 32. Subsequently, the driver pushes the upstream portion 50 forward, so that the upstream shaft 30 is brought into serration engagement with the downstream shaft 32. Then the automatic driving switch 164 is turned to OFF, and the rotation lock device 70 is operated to disengage the lock pin 72 from the one of the engagement recesses 30r so as to move the lock pin 72 to the retracted position. Thus, the steering operating member 2 and the upstream shaft 30 are allowed to rotate relative to the upstream column 44 about the axis. The coupling mechanism 7 is switched to the mechanically coupling state, and the driving state of the vehicle is switched to the manual driving state.

### Second Embodiment

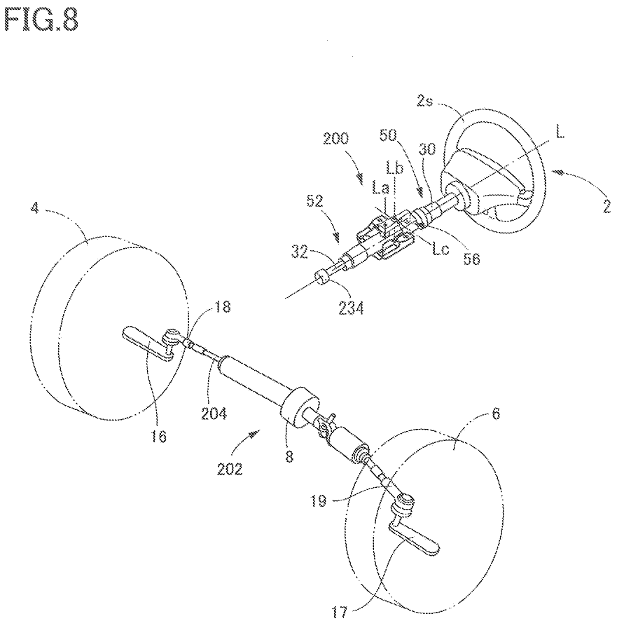

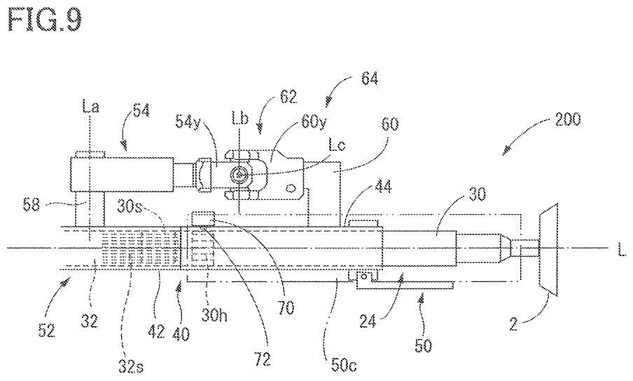

The present disclosure is applicable to a steer-by-wire steering system. In the steer-by-wire steering system, a steering operating device 200 and a steering mechanism 202 are always in a separated state as illustrated in FIGS. 8 and 9. In the steer-by-wire steering system, a steering rod 204 is moved by the automatic steering device 8, and the front right and left wheels 4, 6 are steered via the tie rods 18, 19 and the knuckle link members 16, 17. The steering operating device 200 of the second embodiment is similar in construction to the steering operating device 80 of the first embodiment. Accordingly, the same reference signs as used in the first embodiment are used to identify the corresponding components in the second embodiments of FIGS. 8-10, and detailed explanation thereof is dispensed with.

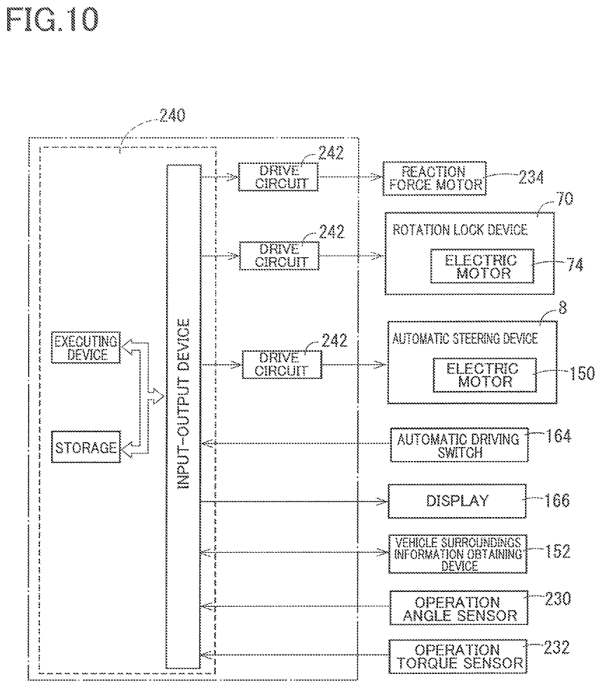

In the steering operating device 200 of the second embodiment, an operation angle sensor 230 for detecting a rotation angle of the steering operating member 2 is provided for the upstream shaft 30, as illustrated in FIG. 10. There are provided, for the downstream shaft 32, a reaction force motor 234 and an operation torque sensor 232 for detecting an operation torque applied to the steering operating member 2. To the downstream shaft 32, a reaction force based on the detection value by the operation angle sensor 230 is applied. The operation torque sensor 232 detects a torque applied by the reaction force motor 234.

To a controller 240 principally constituted by a computer, the operation angle sensor 230, the operation torque sensor 232, the vehicle surroundings information obtaining device 152, the automatic driving switch 164, the display 166, etc., are connected. Further, the reaction force motor 234, the electric motor 74 of the rotation lock device 70, the electric motor 150 of the automatic steering device 8, etc., are connected to the controller 240 via respective drive circuits 242.

In the manual driving state, a target value of the steering angle of the steerable wheels 4, 6 is obtained based on the detection values detected by the operation angle sensor 230 and the operation torque sensor 232, and the electric motor 150 is controlled in accordance with the target value of the steering angle. The reaction force motor 234 is controlled based on the detection value by the operation angle sensor 230. In the automatic driving state, the target value of the steering angle of the steerable wheels 4, 6 is obtained based on the object present in the surroundings of the vehicle and the lane line obtained by the vehicle surroundings information obtaining device 152, and the electric motor 150 is controlled in accordance with the target value of the steering angle.

Switching between the manual driving state and the automatic driving state is executed similarly in the first embodiment. When the driving state of the vehicle is switched from the manual driving state to the automatic driving state, the automatic driving switch 164 is turned to ON, and the rotation lock device 70 is operated to prohibit the rotation of the steering operating member 2. Subsequently, the upstream portion 50 is pulled rearward, so that the upstream shaft 30 is separated from the downstream shaft 32. After having been moved in the width direction of the vehicle, the upstream portion 50 is pivoted upward. The reaction force motor 234 is provided not for the upstream portion 50 but for the downstream portion 52, thus facilitating the operation by the driver.

The steering operating member 2 may have any shape. The steering operating member 2 may have a generally circular shape or may be shaped like a lever. The steering operating member holder 92 may have any structure as long as the holder 92 is capable of holding the upwardly pivoted upstream portion.

At least one of the engaging and separating action of the upstream shaft 30 and the downstream shaft 32, the moving action of the upstream portion 50 in the width direction relative to the downstream portion 52, and the pivoting action of the upstream portion 50 in the up-down direction relative to the downstream portion 52 may be performed by an actuator. It is to be understood that the present disclosure is not limited to the details of the embodiments illustrated above but may be embodied with various changes and modifications based on the knowledge of those skilled in the art.

### Claimabe Invention

(1) A steering operating device provided for a vehicle whose driving state is switchable between a manual driving state and an automatic driving state and including a steering operating member operable by a driver, comprising:

an upstream portion including the steering operating member;

a downstream portion located downstream of the upstream portion; and

a link member connecting the upstream portion and the downstream portion,

wherein the link member connects the upstream portion and the downstream portion such that the upstream portion is movable relative to the downstream portion in a width direction of the vehicle and such that the upstream portion is pivotable relative to the downstream portion in an up-down direction of the vehicle.

The link member, the downstream portion, and the upstream portion constitute a link mechanism.

(2) The steering operating device according to the form (1),

wherein the upstream portion includes an upstream shaft that is rotatable integrally with the steering operating member and an upstream column holding the upstream shaft,

wherein the downstream portion includes a downstream shaft that is engageable with and separable from the upstream shaft and a downstream column holding the downstream shaft and provided on a body of the vehicle so as to be immovable relative to the body of the vehicle, and

wherein the link member connects the upstream column and the downstream column.

(3) The steering operating device according to the form (2),

wherein the link member is connected to the downstream column so as to be pivotable about an axis extending in the up-down direction of the vehicle, and

wherein the upstream column is connected to the link member via a joint so as to be pivotable at least about the axis extending in the up-down direction of the vehicle and an axis extending in a horizontal direction.

The joint may be a ball joint, a cross joint, or the like.

(4) The steering operating device according to any one of the forms (1) through (3), wherein the link member is configured to extend and contract.

The link member may have a telescopic structure.

(5) The steering operating device according to any one of the forms (1) through (4), wherein the upstream portion includes a rotation lock device configured to prohibit rotation of the steering operating member.

(6) The steering operating device according to the form (5),

wherein the upstream portion includes an upstream shaft that is rotatable integrally with the steering operating member and an upstream column holding the upstream shaft, and

wherein the rotation lock device is switchable between a state in which the rotation lock device prohibits rotation of the upstream shaft relative to the upstream column and a state in which the rotation lock device allows the rotation of the upstream shaft relative to the upstream column.

(7) The steering operating device according to the form (6),

wherein the rotation lock device includes:

a plurality of engagement recesses formed at an outer circumferential portion of the upstream shaft;

a lock pin movable between a retracted position at which the lock pin is spaced apart from the engagement recesses of the upstream shaft and an engaging position at which the lock pin is in engagement with one of the engagement recesses; and

a drive device configured to move the lock pin between the retracted position and the engaging position.

In the illustrated embodiments, the drive device may include the electric motor 74 and the motion converting mechanism (the rack and pinion mechanism) 76 for converting rotation of the electric motor 74 into a linear movement of the lock pin 72.

(8) The steering operating device according to any one of the forms (1) through (7), further comprising a steering operating member holder provided for a pillar of the vehicle and configured to hold the steering operating member.

(9) The steering operating device according to any one of the forms (1) through (8),

wherein the downstream portion includes a downstream shaft located downstream of the upstream shaft that is rotatable integrally with the steering operating member, the downstream shaft being engageable with and separable from the upstream shaft, and

wherein the steering operating device further includes a reaction force motor provided for the downstream shaft.

(10) The steering operating device according to any one of the forms (1) through (8),

wherein the downstream portion includes a downstream shaft located downstream of the upstream shaft that is rotatable integrally with the steering operating member, the downstream shaft being engageable with and separable from the upstream shaft, and

wherein the downstream shaft is connected to a rack bar in a gear box.

(11) A steering system provided for a vehicle whose driving state is switchable between a manual driving state and an automatic driving state and including a coupling mechanism configured to couple a steering operating member operable by a driver and at least one steerable wheel of the vehicle, comprising:

a steering mechanism configured to steer the at least one steerable wheel;

a steering operating device including the steering operating member; and

a steering shaft that connects the steering operating member and the steering mechanism,

wherein the steering operating device includes an upstream portion including the steering operating member, a downstream portion located downstream of the upstream portion, and a link member connecting the upstream portion and the downstream portion, and

wherein the link member connects the upstream portion and the downstream portion such that the upstream portion is movable relative to the downstream portion in a width direction of the vehicle and such that the upstream portion is pivotable relative to the downstream portion in an up-down direction of the vehicle.

The steering operating device in this form may be the steering operating device according to any one of the forms (1) through (10).

(12) The steering system according to the form (11),

wherein the steering shaft includes an upstream shaft and a downstream shaft that are engageable with and separable from each other,

wherein the upstream portion includes the upstream shaft,

wherein the downstream portion includes the downstream shaft, and

wherein the coupling mechanism includes the steering shaft and the steering mechanism.

The steering shaft is connected, in the gear box, to the rack bar as one constituent component of the steering mechanism.

(13) The vehicle steering system according to the form (12), wherein the upstream shaft and the downstream shaft are held in serration engagement with each other.

What is claimed is:

1. A steering operating device provided for a vehicle whose driving state is switchable between a manual driving state and an automatic driving state and including a steering operating member operable by a driver, comprising:
an upstream portion including the steering operating member;
a downstream portion located downstream of the upstream portion; and
a link member connecting the upstream portion and the downstream portion,
wherein the link member connects the upstream portion and the downstream portion such that the upstream portion is movable relative to the downstream portion in a width direction of the vehicle and such that the upstream portion is pivotable relative to the downstream portion in an up-down direction of the vehicle.

2. The steering operating device according to claim 1,
wherein the upstream portion includes an upstream shaft that is rotatable integrally with the steering operating member and an upstream column holding the upstream shaft,
wherein the downstream portion includes a downstream shaft that is engageable with and separable from the upstream shaft and a downstream column holding the downstream shaft and provided on a body of the vehicle so as to be immovable relative to the body of the vehicle, and
wherein the link member connects the upstream column and the downstream column.

3. The steering operating device according to claim 2,
wherein the link member is connected to the downstream column so as to be pivotable about an axis extending in the up-down direction of the vehicle, and
wherein the upstream column is connected to the link member via a joint so as to be pivotable at least about the axis extending in the up-down direction of the vehicle and an axis extending in a horizontal direction.

4. The steering operating device according to claim 1, wherein the link member is configured to extend and contract.

5. The steering operating device according to claim 1, wherein the upstream portion includes a rotation lock device configured to prohibit rotation of the steering operating member.

6. The steering operating device according to claim 5,
wherein the upstream portion includes an upstream shaft that is rotatable integrally with the steering operating member and an upstream column holding the upstream shaft, and
wherein the rotation lock device is switchable between a state in which the rotation lock device prohibits rotation of the upstream shaft relative to the upstream column and a state in which the rotation lock device allows the rotation of the upstream shaft relative to the upstream column.

7. The steering operating device according to claim 1, further comprising a steering operating member holder provided for a pillar of the vehicle and configured to hold the steering operating member.

8. The steering operating device according to claim 1,
wherein the downstream portion includes a downstream shaft located downstream of the upstream shaft that is rotatable integrally with the steering operating member, the downstream shaft being engageable with and separable from the upstream shaft, and
wherein the steering operating device further includes a reaction force motor provided for the downstream shaft.

9. The steering operating device according to claim 1,
wherein the downstream portion includes a downstream shaft located downstream of the upstream shaft that is rotatable integrally with the steering operating member, the downstream shaft being engageable with and separable from the upstream shaft, and
wherein the downstream shaft is connected to a rack bar in a gear box.

10. A steering system provided for a vehicle whose driving state is switchable between a manual driving state and an automatic driving state and including a coupling mechanism configured to couple a steering operating member operable by a driver and at least one steerable wheel of the vehicle, comprising:
a steering mechanism configured to steer the at least one steerable wheel;
a steering operating device including the steering operating member; and
a steering shaft that connects the steering operating member and the steering mechanism,
wherein the steering operating device includes an upstream portion including the steering operating member, a downstream portion located downstream of the upstream portion, and a link member connecting the upstream portion and the downstream portion, and
wherein the link member connects the upstream portion and the downstream portion such that the upstream portion is movable relative to the downstream portion in a width direction of the vehicle and such that the upstream portion is pivotable relative to the downstream portion in an up-down direction of the vehicle.

11. The steering system according to claim 10,
wherein the steering shaft includes an upstream shaft and a downstream shaft that are engageable with and separable from each other,
wherein the upstream portion includes the upstream shaft,
wherein the downstream portion includes the downstream shaft, and
wherein the coupling mechanism includes the steering shaft and the steering mechanism.
